(19) United States
(12) Patent Application Publication
(10) Pub. No.: US 2013/0248569 A1
(43) Pub. Date: Sep. 26, 2013

(54) ELECTRONIC DEVICE HOLDER FOR A BICYCLE

(71) Applicant: JUNG TSAN HSU, CHANGHUA COUNTY (TW)

(72) Inventor: JUNG TSAN HSU, CHANGHUA COUNTY (TW)

(73) Assignee: U-LIX IND. CO. LTD., CHANGHUA COUNTY (TW)

(21) Appl. No.: 13/428,169

(22) Filed: Mar. 23, 2012

(51) Int. Cl. B62J 11/00

(52) U.S. Cl. 224/440

(57) ABSTRACT

An electronic device holder for a bicycle, which consists of a fixed base, a belt body, a support unit, a left clamp and a right clamp, wherein the belt is passed through the fixed base and fixed on a bicycle handle, a first connector is set on one side of the fixed base, the first connector is connected to a second connector of the support unit, at least a chute is set on the left side and the right side of the support unit respectively that the left clamp and the right clamp may be slipped laterally along the chute, to thereby fixedly clamp a portable electronic device and achieve the purpose of using the electronic device conveniently when riding.

### BACKGROUND OF THE INVENTION

1. Field of the Invention

The invention relates to an electronic device holder for a bicycle and, more particularly, to an electronic device holder for placing a portable electronic device on a bicycle, to thereby use the electronic device when riding the bicycle and achieve the purpose of conveniently installing and removing.

2. Brief Description of the Related Art

With the popularity of cycling, nowadays, riding bicycles has become one of the popular fitness and leisure activities. In the long-distance riding, some portable electronic devices are often needed for using along with users, such as the path navigation of a smart phone or a navigation device, to avoid disoriented and taking the wrong way without obvious signs in the wild. Although some of the present bike accessories may provide the design for placing the portable electronic devices, they are not ideal in use or not necessarily usable. It is mainly because the specifications and species of electronic devices are various, once when not being usable, riders may only put electronic devices inside the pockets or bags in a difficult way, and take out for looking during riding, thus it is really inconvenient.

### SUMMARY OF THE INVENTION

In view of this, the inventor finally completes the invention after numerous improvements, namely, the object of the invention is to provide an electronic device holder for a bicycle, to thereby use the electronic device when riding the bicycle and achieve the purpose of conveniently installing and removing.

To achieve the object, the electronic device holder for a bicycle according to the present invention consists of a fixed base, a belt body, a support unit, a left clamp and a right clamp, wherein:

the fixed base, a lateral hole is set on its base body, a concave hole is set on the bottom side of the base body, a soft cushion block is placed inside the concave hole, a lateral aperture is set on the block body of the soft cushion block, the lateral aperture is corresponding to the lateral hole on the base body, one side of the base body is extended and a first connector is set on it, a locking hole is set on the first connector for screwing a fixing bolt;

the belt body, which is passed through the lateral aperture of the fixed base, the first end of the belt body is a threaded end, the second end of the belt body has a ring sleeve for placing a frame of a buckle, a threaded hole is set on the buckle for threading the first end of the belt body, one surface of the belt body has a surface with velcro-function;

the support unit, which is a baffle extended forward from the lower end of a flat board, a second connector is extended from one side of the baffle, a spring is set on the front end of the second connector, a locking hole set on the second connector is corresponded to the locking hole of the first connector for fixedly screwing a passed-through fixing bolt on a nut, and a first chute and a second chute corresponding mutually are set on the left side and the right side of the flat board;

the left clamp, which is consisted of a U-shaped plate body, is placed on the left side of the flat board of the support unit, the U-shaped plate body has an opening containing chamber, a first hook columns is set on the back side of the left clamp corresponding to the first chute, a location column is set on the front side of the first hook column, the location column is wrapped in a spring and limited in the first chute;

the right clamp, which is consisted of a U-shaped plate body, is placed on the right side of the flat board of the support unit, the U-shaped plate body has an opening containing chamber, a second hook columns is set on the back side of the right clamp corresponding to the second chute, a location column is set on the front side of the second hook column, the location column is wrapped in a spring and limited in the second chute.

The abovementioned left clamp, wherein the width of the front side of the U-shaped plate body of the left clamp is smaller than the width of its back side.

The abovementioned right clamp, wherein the width of the front side of the U-shaped plate body of the right clamp is smaller than the width of its back side.

### BRIEF DESCRIPTION OF THE INVENTION

The detail structure, the applied principle, the function and the effectiveness of the present invention can be more fully understood with reference to the following description and accompanying drawings, in which:

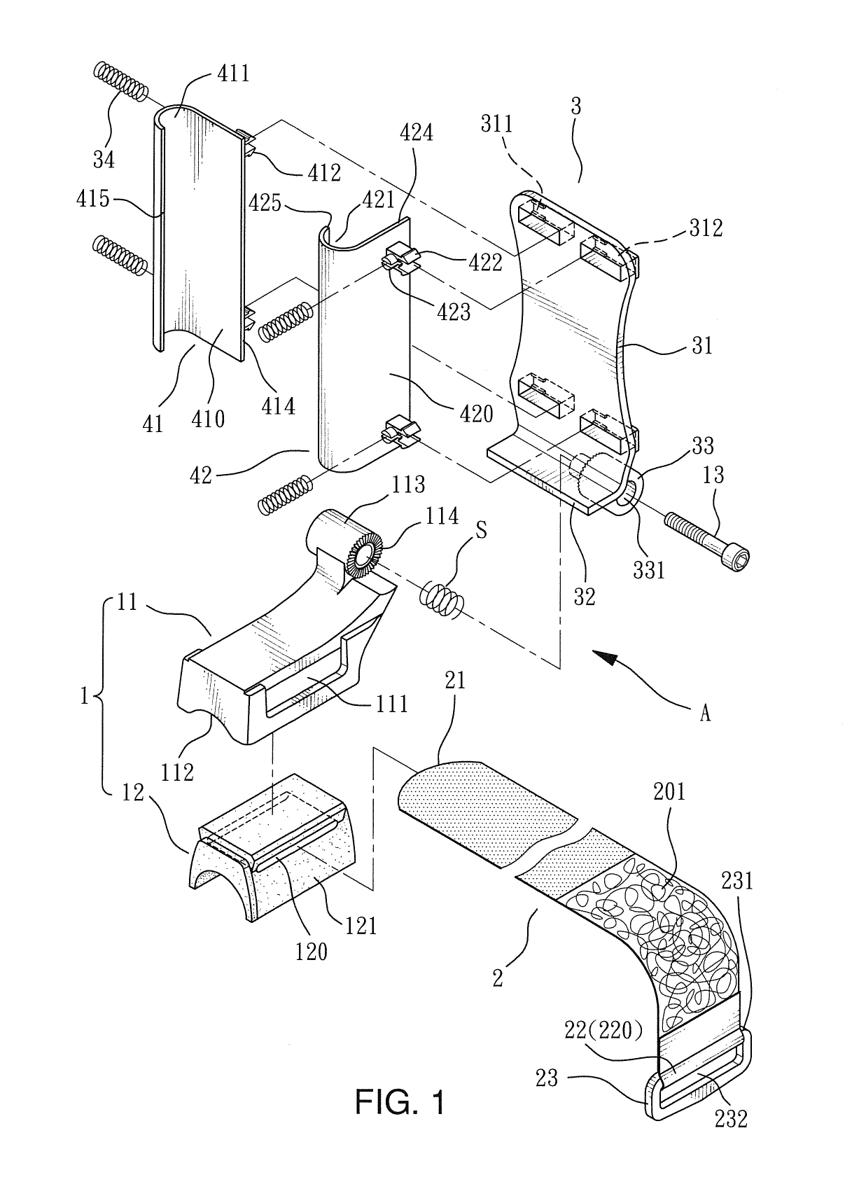

FIG. 1 is a three-dimensional exploded diagram according to the present invention;

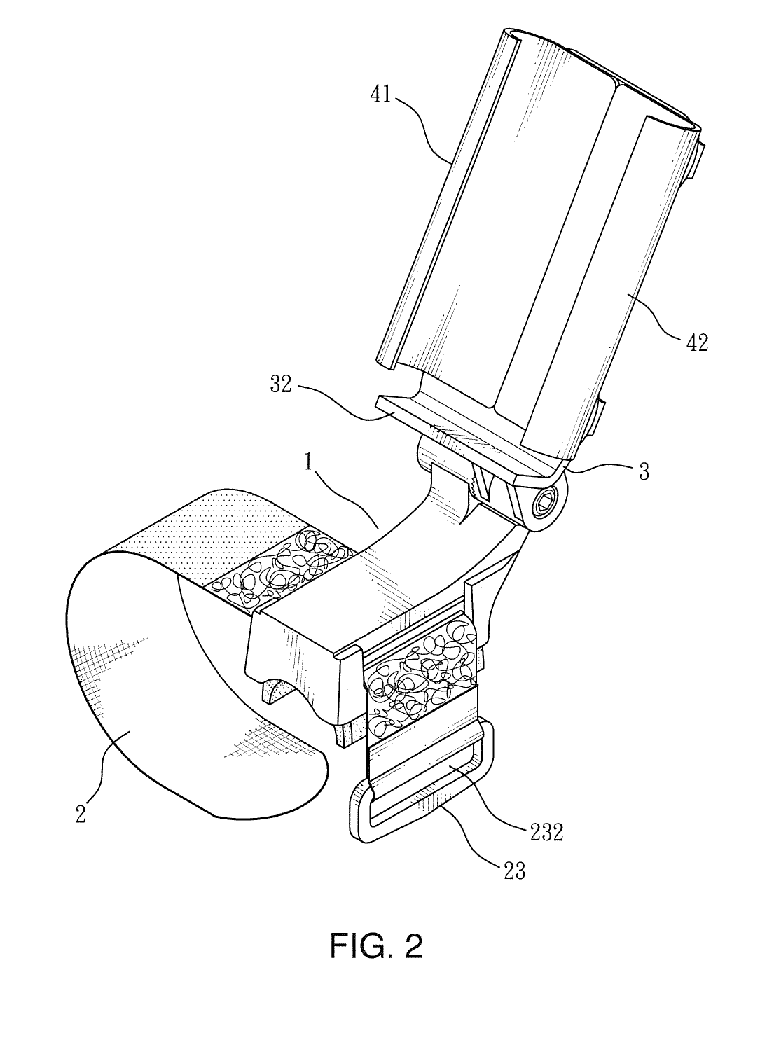

FIG. 2 is a three-dimensional diagram according to the present invention;

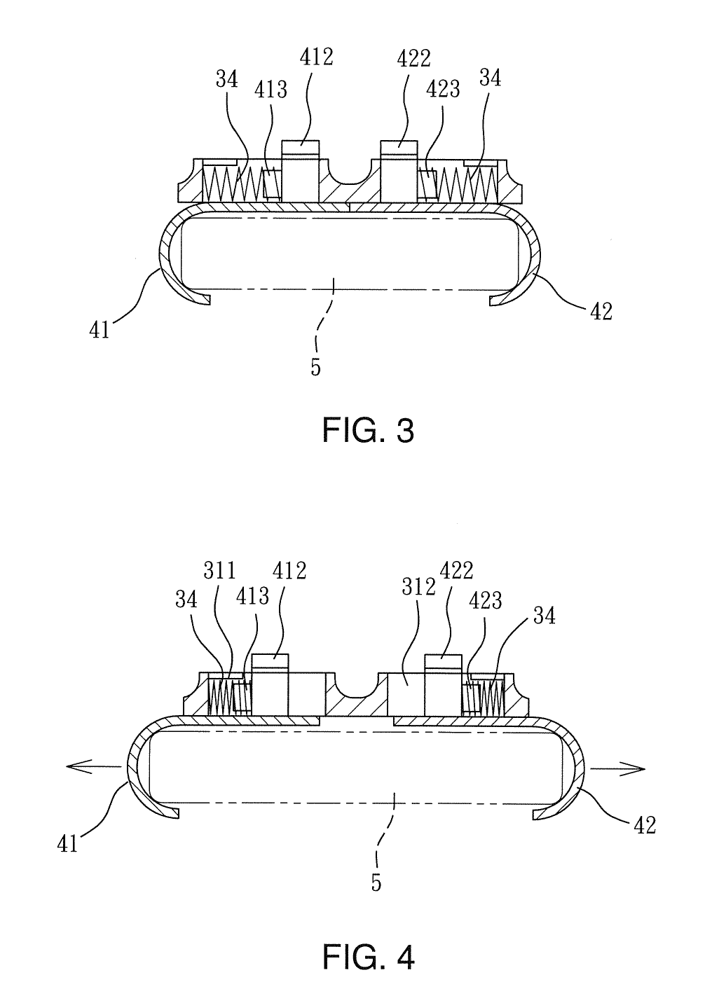

FIG. 3 is a schematic diagram (1) of action according to the present invention;

FIG. 4 is a schematic diagram (2) of action according to the present invention;

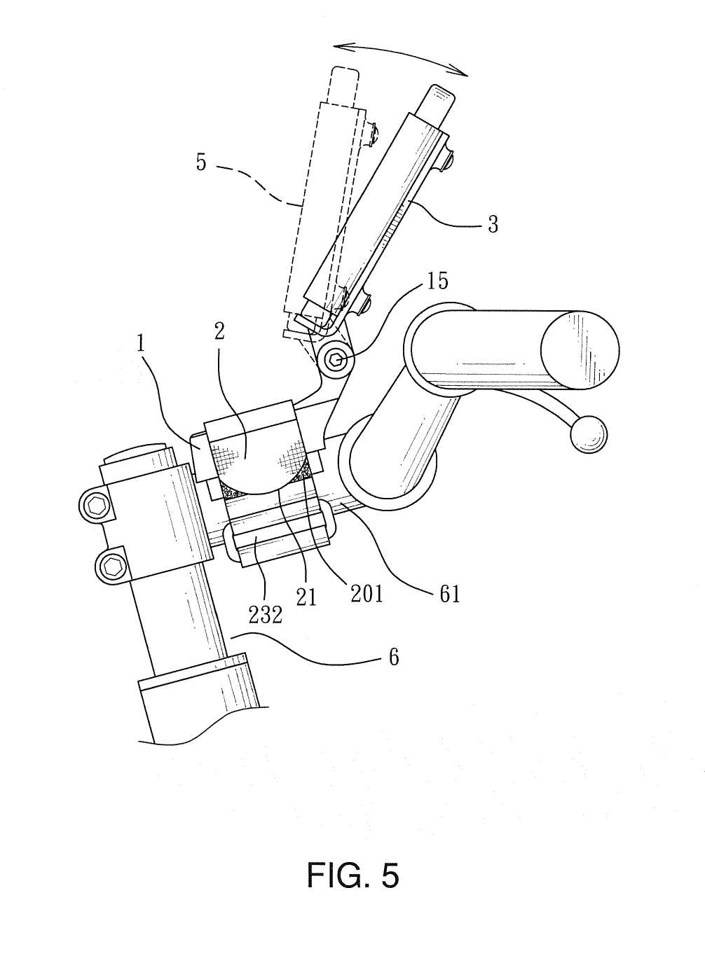

FIG. 5 is a schematic diagram (3) of action according to the present invention; and

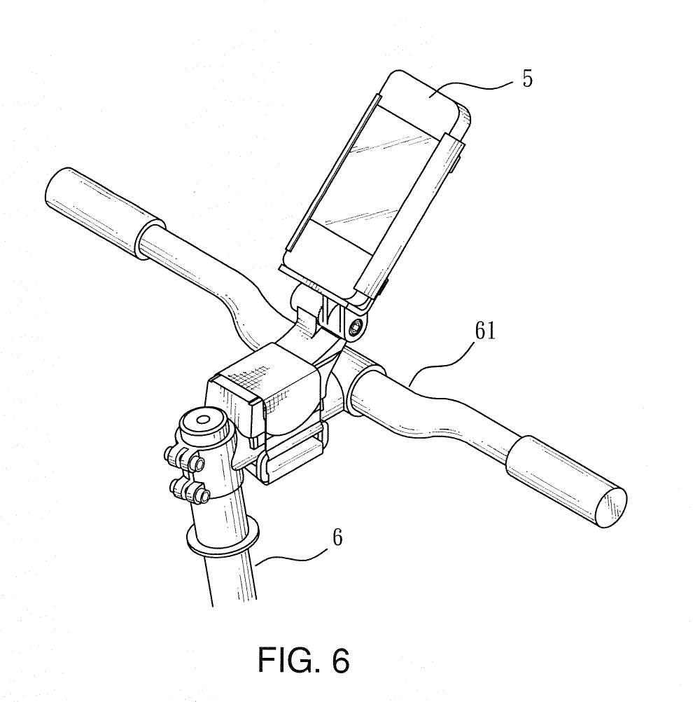

FIG. 6 is a schematic diagram of the embodiment according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

Please refer to FIG. 1 and FIG. 2, the electronic device holder A for a bicycle according to the present invention consists of a fixed base 1, a belt body 2, a support unit 3, a left clamp 41 and a right clamp 42, wherein:

the fixed base 1, a lateral hole 111 is set on its base body 11, a concave hole 112 is set on the bottom side of the base body 11, a soft cushion block 12 is placed inside the concave hole 112, a lateral aperture 120 is set on the block body 121 of the soft cushion block 12, the lateral aperture 120 is corresponding to the lateral hole 111 on the base body 11, one side of the base body 11 is extended and a first connector 113 is set on it, a locking hole 114 is set on the first connector 113 for screwing a fixing bolt 13;

the belt body 2, which is passed through the lateral aperture 120 of the fixed base 1, the first end 21 of the belt body 2 is a threaded end, the second end 22 of the belt body 21 has a ring sleeve 220 for placing a frame 231 of a buckle 23, a threaded hole 232 is set on the buckle 23 for threading the first end 21 of the belt body 23, one surface 201 of the belt body 2 has a surface with velcro-function;

the support unit 3, which is a baffle 32 extended forward from the lower end of a flat board 31, a second connector 33 is extended from one side of the baffle 32, a spring S is set on the front end of the second connector 33, a locking hole 331 set on the second connector 33 is corresponded to the locking hole 114 of the first connector 113 for fixedly screwing a passed-through fixing bolt 13, and a first chute 311 and a second chute 312 corresponding mutually are set on the left side and the right side of the flat board 31;

the left clamp 41, which is consisted of a U-shaped plate body 410, is placed on the left side of the flat board 31 of the support unit 3, the U-shaped plate body 410 has an opening containing chamber 411, a first hook column 412 is set on the back side of the left clamp 41 corresponding to the first chute 311, a location column 413 is set on the front side of the first hook column 412 (as shown in FIG. 4), the location column 413 is wrapped in a spring 34 and limited in the first chute 311;

the right clamp 42, which is consisted of a U-shaped plate body 420, is placed on the right side of the flat board 31 of the support unit 3, the U-shaped plate body 420 has an opening containing chamber 421, a second hook columns 422 is set on the back side of the right clamp 42 corresponding to the second chute 312, a location column 423 is set on the front side of the second hook column 422, the location column 423 is wrapped in a spring 34 and limited in the second chute 312.

By the composition of the above elements (as shown in FIG. 1, FIG. 3 and FIG. 4), when setting up, first attaching the fixed base 1 with the soft cushion block 12 on the bottom side on the handle lever 61 of the bicycle 6 (as shown in FIG. 5 and FIG. 6), surrounding the handle lever 61 with the first end 21 of the belt body 2 that is passed through the lateral aperture 120 of the fixed base 1, passing the first end 21 through the threaded hole 232 and tightening, and partly posting redundant belt body 2 on the surface 201 of the surrounded part. Since the surface 201 of the belt body 2 has velcro-function, it may be bonded, not easy to fall off or move. Next, users may loose the fixing bolt 13 by using tools, adjust the support unit 3 to an ideal position for placing, watch and operate an electronic device 5, and lock the fixing bolt 13 after adjusting. When riding the bicycle 6, users may pull open the left clamp 41 and the right clamp 42 by fingers, and loosing the left clamp 41 and the right clamp 42 after putting the electronic device 5 in the inner containing chambers 411, 421. Since the elasticity of the spring 34, the first hook column 412 and the second hook column 422 respectively move along the first chute 311 and the second chute 312, and the left clamp 41 and the right clamp 42 are linked to clamp the electronic device tightly, to thereby provide the purpose of conveniently operating and watching the electronic device 5 when riding the bicycle (such as watching the navigation path or operating the phone).

Besides, if users want to remove the holder A, taking out the electronic device 5 from the inner containing chambers 411, 421 of the left clamp 41 and the right clamp 42, pulling the first end 21 of the belt body 2 reversely by fingers, the belt body 2 may be away from the bonded surface 201 and the holder A may be removed from the handle lever 61.

The above left clamp 41, wherein the width of the front side 415 of the U-shaped plate body 410 is smaller than the width of the back side 414 of the U-shaped plate body 410.

The above right clamp 42, wherein the width of the front side 425 of the U-shaped plate body 420 is smaller than the width of the back side 424 of the U-shaped plate body 420.

Above all, the holder of the present invention may be generally installed on various handle levers with different specification, and all kinds of electronic devices may be clamped due to the removable left and right clamps. Otherwise, the present invention may be installed and removed conveniently, the drawbacks of the conventional design may be improved and the present invention has innovation and progressive effectiveness.

I claim:

1. An electronic device holder for a bicycle, which consists of a fixed base, a belt body, a support unit, a left clamp and a right clamp, wherein:
the fixed base, a lateral hole is set on its base body, a concave hole is set on the bottom side of the base body, a soft cushion block is placed inside the concave hole, a lateral aperture is set on the block body of the soft cushion block, the lateral aperture is corresponding to the lateral hole on the base body, one side of the base body is extended and a first connector is set on it, a locking hole is set on the first connector for screwing a fixing bolt;
the belt body, which is passed through the lateral aperture of the fixed base, the first end of the belt body is a threaded end, the second end of the belt body has a ring sleeve for placing a frame of a buckle, a threaded hole is set on the buckle for threading the first end of the belt body, one surface of the belt body has a surface with velcro-function;
the support unit, which is a baffle extended forward from the lower end of a flat board, a second connector is extended from one side of the baffle, a spring is set on the front end of the second connector, a locking hole set on the second connector is corresponded to the locking hole of the first connector for fixedly screwing a passed-through fixing bolt on a nut, and a first chute and a second chute corresponding mutually are set on the left side and the right side of the flat board;
the left clamp, which is consisted of a U-shaped plate body, is placed on the left side of the flat board of the support unit, the U-shaped plate body has an opening containing chamber, a first hook column is set on the back side of the left clamp corresponding to the first chute, a location column is set on the front side of the first hook column, the location column is wrapped in a spring and limited in the first chute;
the right clamp, which is consisted of a U-shaped plate body, is placed on the right side of the flat board of the support unit, the U-shaped plate body has an opening containing chamber, a second hook columns is set on the back side of the right clamp corresponding to the second chute, a location column is set on the front side of the second hook column, the location column is wrapped in a spring and limited in the second chute.

2. The electronic device holder for a bicycle as claimed in claim 1, wherein the width of the front side of the U-shaped plate body of the left clamp is smaller than the width of its back side.

3. The electronic device holder for a bicycle as claimed in claim 1, wherein the width of the front side of the U-shaped plate body of the right clamp is smaller than the width of its back side.
